(19) United States
(12) Patent Application Publication
(10) Pub. No.: US 2026/0301158 A1
(43) Pub. Date: Oct. 1, 2026

(54) INSPECTION APPARATUS AND INSPECTION METHOD

(71) Applicant: Lasertec Corporation, Yokohama (JP)

(72) Inventor: Wataru KUBO, Yokohama (JP)

(21) Appl. No.: 19/633,330

(22) Filed: Mar. 30, 2026

(30) Foreign Application Priority Data
Mar. 31, 2025 (JP) 2025-058157

(51) Int. Cl. G06T 7/00; G01N 21/956

(52) U.S. Cl. CPC G06T 7/001; G01N 21/956; G01N 2021/95676; G06T 2207/30148

(57) ABSTRACT

An inspection apparatus relating to the present disclosure includes a specification unit configured to specify a continuous region in a sample in which a pattern is formed, the continuous region being where a substantially equivalent predetermined property is continuous in a first direction, an acquisition unit configured to acquire a difference image based on a comparison between a captured image and a reference image of the sample, and a determination unit configured to determine a defect, based on a parameter based on the difference image in a center region, a parameter based on the difference image in a first peripheral region more on a first side in the first direction than the center region, and a parameter based on the difference image in a second peripheral region more on a second side in the first direction than the center region.

### INCORPORATION BY REFERENCE

This application is based upon and claims the benefit of priority from Japanese Patent Application No. 2025-058157, filed on Mar. 31, 2025, the disclosure of which is incorporated herein in its entirety by reference for all purposes.

### BACKGROUND

The present disclosure relates to an inspection apparatus and an inspection method.

Japanese Unexamined Patent Application Publication No. 2021-143840 describes an inspection apparatus that inspects a defect of a semiconductor related sample such as a mask, by using an optical apparatus.

### SUMMARY

Defect shapes and inspection target regions to be detected have diversified, as a result of miniaturization and complication of the structure of semiconductor related samples in recent years. Since a defect in a semiconductor related sample exerts an influence on the yield rate or the device operation of a semiconductor device, it is necessary for a defect to be appropriately detected.

The present disclosure has been made to solve such a problem, and an objective of the present disclosure is to provide an inspection apparatus and an inspection method that can improve an inspection accuracy of a defect.

An inspection apparatus relating to the present disclosure includes a specification unit configured to specify a continuous region in a sample in which at least one pattern is formed, the continuous region being where a substantially equivalent predetermined property is continuous in a first direction, an acquisition unit configured to acquire a difference image based on a comparison between a captured image and a reference image of the sample, and a determination unit configured to determine a defect in a predetermined processing region within a region corresponding to the continuous region in the difference image, the defect being based on a parameter based on the difference image in a center region, a parameter based on the difference image in a first peripheral region more on a first side in the first direction than the center region, and a parameter based on the difference image in a second peripheral region more on a second side in the first direction than the center region.

In the above described inspection apparatus, the determination unit may be configured to specify a defect candidate region that includes a pixel having a parameter of a predetermined range in the difference image, and the determination unit may be configured to set a region that includes the defect candidate region as the processing region.

In the above described inspection apparatus, the determination unit may be configured to convert a parameter of each pixel of the difference image into a conversion parameter by applying a conversion operator to the processing region, the conversion operator being configured to convert the parameter, and the determination unit may be configured to determine the defect based on the converted conversion parameter.

In the above described inspection apparatus, the conversion operator may be a kernel having a center part that includes one or more cells, a first peripheral part that includes two or more cells more on the first side than the center part, and a second peripheral part that includes two or more cells more on the second side than the center part, the determination unit may be configured to calculate a first defect signal from the parameter of a concerned pixel and a first statistical value in the parameter of a first peripheral region pixel group consisting of pixels of the difference image at positions corresponding to the cells of the first peripheral part, the concerned pixel being a pixel of the difference image at a position corresponding to each of the one or more cells of the center part, the determination unit may be configured to calculate a second defect signal from the parameter of the concerned pixel and a second statistical value in the parameter of a second peripheral region pixel group consisting of pixels of the difference image at positions corresponding to the cells of the second peripheral part, and the determination unit may be configured to convert the parameter of the concerned pixel into the conversion parameter based on a condition satisfied by the first defect signal and the second defect signal.

In the above described inspection apparatus, the first statistical value and the second statistical value may each include at least one of an average value and a standard deviation.

In the above described inspection apparatus, the condition may include a first condition that a sign of the first defect signal and a sign of the second defect signal are equal to each other, and the condition may include a second condition that an absolute value of the first defect signal is larger than a value obtained by dividing an absolute value of the second defect signal by a number larger than 1 and an absolute value of the second defect signal is larger than a value obtained by dividing an absolute value of the first defect signal by a number larger than 1.

In the above described inspection apparatus, the determination unit may be configured to convert the parameter of the concerned pixel into a defect signal sum in a case where both of the first condition and the second condition are satisfied, the defect signal sum being a sum of the first defect signal and the second defect signal, and the determination unit may be configured to convert the parameter of the concerned pixel into a specific value in a case where at least one of the first condition and the second condition is not satisfied.

In the above described inspection apparatus, the determination unit may be configured to determine the defect in the center region based on a first defect signal in which a parameter of a pixel of the difference image in the center region is corrected based on a first statistical value of a parameter of a pixel of the difference image in the first peripheral region, and a second defect signal in which a parameter of a pixel of the difference image in the center region is corrected based on a second statistical value of a parameter of a pixel of the difference image in the second peripheral region.

In the above described inspection apparatus, the determination unit may be configured to determine the defect in the center region based on a first condition that includes a sign of the first defect signal and a sign of the second defect signal having a predetermined relationship.

In the above described inspection apparatus, the determination unit may be configured to determine the defect in the center region based on a second condition that includes both of the first defect signal and the second defect signal having a large value to the same extent.

In the above described inspection apparatus, the determination unit may be configured to determine the defect in the center region in a case where both a first condition that includes a sign of the first defect signal and a sign of the second defect signal having a predetermined relationship and a second condition that includes both of the first defect signal and the second defect signal having a large value to the same extent are satisfied.

In the above described inspection apparatus, the sample may have a plurality of groups spaced apart in the first direction, each of the groups being where two of the at least one pattern extending in a second direction intersecting the first direction and/or two pattern intervals extending in a second direction intersecting the first direction are adjacent in the second direction with at least one gap portion interposed therebetween, and the continuous region may include a plurality of the at least one gap portion arranged in a row in the first direction.

In the above described inspection apparatus, the sample may have a plurality of groups spaced apart in the first direction, each of the groups being of a plurality of circular patterns arranged in a row with at least one gap portion interposed therebetween in a second direction intersecting the first direction, and the continuous region may include a plurality of the at least one gap portion arranged in a row in the first direction.

In the above described inspection apparatus, the sample may include the defect in the gap portion.

An inspection method relating to the present disclosure includes the steps of: specifying a continuous region in a sample in which at least one pattern is formed, the continuous region being where a substantially equivalent predetermined property is continuous in a first direction, acquiring a difference image based on a comparison between a captured image and a reference image of the sample, and determining a defect in a predetermined processing region within a region corresponding to the continuous region in the difference image, based on a parameter based on the difference image in a center region, a parameter based on the difference image in a first peripheral region more on a first side in the first direction than the center region, and a parameter based on the difference image in a second peripheral region more on a second side in the first direction than the center region.

In the above described inspection method, in the step of determining, a defect candidate region that includes a pixel having a parameter of a predetermined range in the difference image may be specified, and a region that includes the defect candidate region may be set as the processing region.

In the above described inspection method, in the step of determining, a parameter of each pixel of the difference image may be converted into a conversion parameter by applying a conversion operator to the processing region, the conversion operator being configured to convert the parameter, and the defect may be determined based on the converted conversion parameter.

In the above described inspection method, the conversion operator may be a kernel having a center part that includes one or more cells, a first peripheral part that includes two or more cells more on the first side than the center part, and a second peripheral part that includes two or more cells more on the second side than the center part, in the step of determining, a first defect signal may be calculated from the parameter of a concerned pixel and a first statistical value in the parameter of a first peripheral region pixel group consisting of pixels of the difference image at positions corresponding to the cells of the first peripheral part, the concerned pixel being a pixel of the difference image at a position corresponding to each of the one or more cells of the center part, a second defect signal may be calculated from the parameter of the concerned pixel and a second statistical value in the parameter of a second peripheral region pixel group consisting of pixels of the difference image at positions corresponding to the cells of the second peripheral part, and the parameter of the concerned pixel may be converted into the conversion parameter based on a condition satisfied by the first defect signal and the second defect signal.

In the above described inspection method, the first statistical value and the second statistical value may each include at least one of an average value and a standard deviation.

In the above described inspection method, in the step of determining, the condition may include a first condition that a sign of the first defect signal and a sign of the second defect signal are equal to each other, and the condition may include a second condition that an absolute value of the first defect signal is larger than a value obtained by dividing an absolute value of the second defect signal by a number larger than 1 and an absolute value of the second defect signal is larger than a value obtained by dividing an absolute value of the first defect signal by a number larger than 1.

In the above described inspection method, in the step of determining, the parameter of the concerned pixel may be converted into a defect signal sum in a case where both of the first condition and the second condition are satisfied, the defect signal sum being a sum of the first defect signal and the second defect signal, and the parameter of the concerned pixel may be converted into a specific value in a case where at least one of the first condition and the second condition is not satisfied.

In the above described inspection method, in the step of determining, the defect in the center region may be determined based on a first defect signal in which a parameter of a pixel of the difference image in the center region is corrected based on a first statistical value of a parameter of a pixel of the difference image in the first peripheral region, and a second defect signal in which a parameter of a pixel of the difference image in the center region is corrected based on a second statistical value of a parameter of a pixel of the difference image in the second peripheral region.

In the above described inspection method, in the step of determining, the defect in the center region may be determined based on a first condition that includes a sign of the first defect signal and a sign of the second defect signal having a predetermined relationship.

In the above described inspection method, in the step of determining, the defect in the center region may be determined based on a second condition that includes both of the first defect signal and the second defect signal having a large value to the same extent.

In the above described inspection method, in the step of determining, the defect in the center region may be determined in a case where both a first condition that includes a sign of the first defect signal and a sign of the second defect signal having a predetermined relationship and a second condition that includes both of the first defect signal and the second defect signal having a large value to the same extent are satisfied.

In the above described inspection method, the sample may have a plurality of groups spaced apart in the first direction, each of the groups being where two of the at least one pattern extending in a second direction intersecting the first direction and/or two pattern intervals extending in a second direction intersecting the first direction are adjacent in the second direction with at least one gap portion interposed therebetween, and the continuous region may include a plurality of the at least one gap portion arranged in a row in the first direction.

In the above described inspection method, the sample may have a plurality of groups spaced apart in the first direction, each of the groups being of a plurality of circular patterns arranged in a row with at least one gap portion interposed therebetween in a second direction intersecting the first direction, and the continuous region may include a plurality of the at least one gap portion arranged in a row in the first direction.

In the above described inspection method, the sample may include the defect in the gap portion.

According to the present disclosure, an inspection apparatus and an inspection method are provided that can improve an inspection accuracy of a defect.

The above and other objects, features and advantages of the present disclosure will become more fully understood from the detailed description given hereinbelow and the accompanying drawings.

### BRIEF DESCRIPTION OF DRAWINGS

FIG. 1 is a block diagram illustrating an inspection apparatus relating to a first embodiment;

FIG. 2 is a figure illustrating a captured image of a sample, in the inspection apparatus relating to the first embodiment;

FIG. 3 is a figure illustrating a reference image of a sample, in the inspection apparatus relating to the first embodiment;

FIG. 4 is a figure illustrating a difference image of a sample, in the inspection apparatus relating to the first embodiment;

FIG. 5 is a figure illustrating a kernel used by a determination unit, in the inspection apparatus relating to the first embodiment;

FIG. 6 is a figure illustrating a conversion image of a sample, in the inspection apparatus relating to the first embodiment;

FIG. 7 is a figure illustrating a different kernel used by the determination unit, in the inspection apparatus relating to the first embodiment;

FIG. 8 is a block diagram illustrating an information processing apparatus relating to the first embodiment;

FIG. 9 is a flowchart diagram illustrating an inspection method relating to the first embodiment;

FIG. 10 is a figure illustrating a captured image of a sample, in an inspection apparatus relating to a second embodiment;

FIG. 11 is a figure illustrating a reference image of a sample, in the inspection apparatus relating to the second embodiment;

FIG. 12 is a figure illustrating a difference image of a sample, in the inspection apparatus relating to the second embodiment;

FIG. 13 is a figure illustrating a captured image of a sample, in the inspection apparatus relating to the second embodiment;

FIG. 14 is a figure illustrating a reference image of a sample, in the inspection apparatus relating to the second embodiment;

FIG. 15 is a figure illustrating a difference image of a sample, in the inspection apparatus relating to the second embodiment;

FIG. 16 is a figure illustrating a captured image of a sample, in the inspection apparatus relating to the second embodiment;

FIG. 17 is a figure illustrating a reference image of a sample, in the inspection apparatus relating to the second embodiment;

FIG. 18 is a figure illustrating a difference image of a sample, in the inspection apparatus relating to the second embodiment;

FIG. 19 is a block diagram illustrating an inspection apparatus relating to a third embodiment;

FIG. 20 is a flowchart diagram illustrating an inspection method relating to the third embodiment; and

FIG. 21 is a configuration diagram illustrating an inspection apparatus relating to a fourth embodiment.

### DESCRIPTION OF EMBODIMENTS

Hereinafter, specific configurations of the present embodiment will be described by referring to the figures. The following explanations show exemplary embodiments of the present disclosure, and the range of the present disclosure is not limited to the following embodiments. In the following explanations, contents with the same reference numerals attached show substantially similar contents. In order to avoid complicating the figures, several reference numerals and hatchings have been omitted.

### First Embodiment

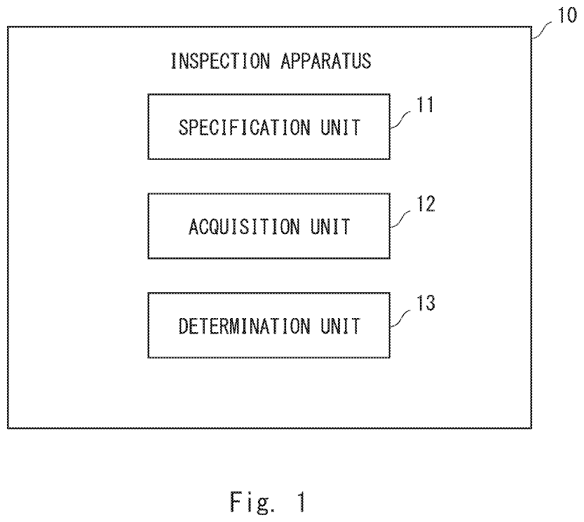

An inspection apparatus relating to a first embodiment will be described. FIG. 1 is a block diagram illustrating an inspection apparatus 10 relating to the first embodiment. As shown in FIG. 1, the inspection apparatus 10 of the present embodiment includes a specification unit 11, an acquisition unit 12, and a determination unit 13.

### (Specification Unit)

The specification unit 11 specifies a continuous region in which a substantially equivalent predetermined property is continuous in a first direction, in a sample in which a pattern is formed. The specification unit 11 may specify the continuous region in which a substantially equivalent predetermined property is continuous in the first direction, in a captured image of a sample in which a pattern is formed, or may specify the continuous region in which a substantially equivalent predetermined property is continuous in the first direction, in a reference image of a sample in which a pattern is formed. As an example, in a case where a difference between a maximum value and a minimum value of a parameter (for example, luminance) of a plurality of pixels of a specific number arranged in a row in an arbitrary direction (vertically, horizontally, diagonally) on an image plane of a captured image G10 or a reference image G20, which will be described below, stays within a predetermined range, the specification unit 11 may set this direction as the first direction, and may specify a region consisting of the plurality of pixels of a specific number arranged in a row in the first direction as the continuous region.

Moreover, the specification unit 11 may specify the continuous region in which a substantially equivalent predetermined property is continuous in the first direction, from design information of the pattern formed in the sample. In this case, identification information that shows the continuous region may be included in the design information.

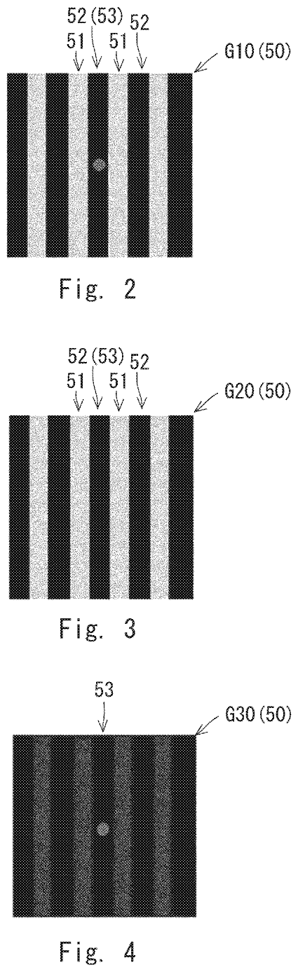

FIG. 2 is a figure illustrating a captured image G10 of a sample 50, in the inspection apparatus 10 relating to the first embodiment. FIG. 3 is a figure illustrating a reference image G20 of the sample 50, in the inspection apparatus 10 relating to the first embodiment. As shown in FIG. 2 and FIG. 3, a pattern 51 that constitutes a line and space may be formed in the sample 50. The pattern 51 may include, for example, a first material that reflects illumination light. A pattern interval 52 between adjacent patterns 51 may include a second material that absorbs illumination light. Or, the pattern 51 may include a first material that transmits illumination light. The pattern interval 52 may include a second material that absorbs or reflects illumination light. As a result of this, a portion of the pattern 51 includes a white colored portion, in the captured image G10 and the reference image G20. Moreover, a portion of the pattern interval 52 includes a black colored portion, in the captured image G10 and the reference image G20. In the following explanation, while a portion of the pattern 51 includes a white colored portion and a portion of the pattern interval 52 includes a black colored portion, it may have a configuration in which a portion of the pattern 51 includes a black colored portion and a portion of the pattern interval 52 includes a white colored portion.

The pattern 51 and the pattern interval 52 each have a portion that extends in one direction. The direction in which the pattern 51 and the pattern interval 52 extend is called the first direction. In this case, the sample 50 has a continuous region 53 in which a substantially equivalent predetermined property is continuous in the first direction. The substantially equivalent predetermined property may be luminance. The continuous region 53 in the captured image G10 corresponds to the continuous region 53 of the sample 50. The continuous region 53 in the captured image G10 may include the pattern interval 52 in which a black colored portion smaller than a predetermined luminance is continuous in the first direction. Moreover, the continuous region 53 in the captured image G10 may include the pattern 51 in which a white colored portion larger than a predetermined luminance is continuous in the first direction. Note that, the substantially equivalent predetermined property is not limited to luminance, and may be another property such as wavelength by the color of reflected light. Moreover, the substantially equivalent predetermined property may be the first material or the second material in the design information. As an example, the specification unit 11 specifies the continuous region 53 that includes the pattern interval 52.

The reference image G20 may be an image that captures the sample 50. For example, the reference image G20 may be an image that captures a sample 50 of good quality such as not including a defect. Moreover, the reference image G20 may be an image that captures a portion different to a portion captured by the captured image G10 in the sample 50. In addition, the reference image G20 may be an image generated from the design information. The continuous region 53 in the reference image G20 corresponds to the continuous region 53 of the sample 50. Similar to the captured image G10, the continuous region 53 in the reference image G20 may include the pattern 51 and may include the pattern interval 52.

### (Acquisition Unit)

FIG. 4 is a figure illustrating a difference image G30 of the sample 50, in the inspection apparatus 10 relating to the first embodiment. As shown in FIG. 4, the acquisition unit 12 acquires the difference image G30 based on a comparison between the captured image G10 and the reference image G20 of the sample 50. The acquisition unit 12 acquires the difference image G30, by taking a difference between the parameter of each pixel in the captured image G10 and the parameter of each pixel in the reference image G20. When taking a difference, the acquisition unit 12 differentiates each pixel in the captured image G10 and each pixel in the reference image G20 corresponding to each of the respective pixels. An image region, in which pixels capturing the continuous region 53 in the captured image G10 and pixels corresponding to the same portion as the continuous region 53 captured by the captured image G10 in the reference image G20 are differentiated, is included in the difference image G30. There may be cases where this image region is called “a region corresponding to the continuous region 53 in the difference image G30”, or there may be cases where this image region is simply called the continuous region 53 of the difference image 30 (the continuous region 53 in the difference image 30). The acquisition unit 12 may differentiate pixels capturing the continuous region 53 in the captured image G10 and pixels corresponding to the same portion as the continuous region 53 captured by the captured image G10 in the reference image G20. The acquisition unit 12 may be capable of acquiring an image based on a comparison between the captured image G10 of the sample 50 and the reference image G20, and the acquisition unit 12 may acquire the difference image G30, by taking a ratio of the parameter of each pixel in the captured image G10 to the parameter of each pixel in the reference image G20.

As an example, the parameter of each pixel of the difference image G30 is luminance (a luminance difference value). The difference image G30 may be a virtual image for a defect determination process, which will be described below, and it is not essential to be generated, displayed or the like as an image. Therefore, the acquisition unit 12 may acquire a comparison parameter, in which the parameter (luminance) of pixels in the captured image G10 of the sample 50 and the parameter (luminance) of pixels in the reference image G20 corresponding to these pixels are compared, for a plurality of pixels. The acquisition unit 12 configured in such a manner is in the range of the technical idea of the present disclosure. Moreover, in the following explanations, the parameter of pixels of the difference image G30 may be replaced by the comparison parameter corresponding to pixels of the captured image G10 or the reference image G20 (the comparison parameter in which the parameter (luminance) of pixels in the captured image G10 of the sample 50 and the parameter (luminance) of pixels in the reference image G20 corresponding to these pixels are compared). Such a configuration is also within the range of the technical idea of the present disclosure.

### (Determination Unit)

The determination unit 13 determines a defect, based on the parameter of pixels of the difference image G30. Specifically, the determination unit 13 determines a defect, based on a parameter based on the difference image G30 in a center region, a parameter based on the difference image G30 in a first peripheral region more on a first side in the first direction than the center region, and a parameter based on the difference image G30 in a second peripheral region more on a second side in the first direction than the center region, in a predetermined processing region within a region corresponding to the continuous region 53 in the difference image G13.

### (Kernel)

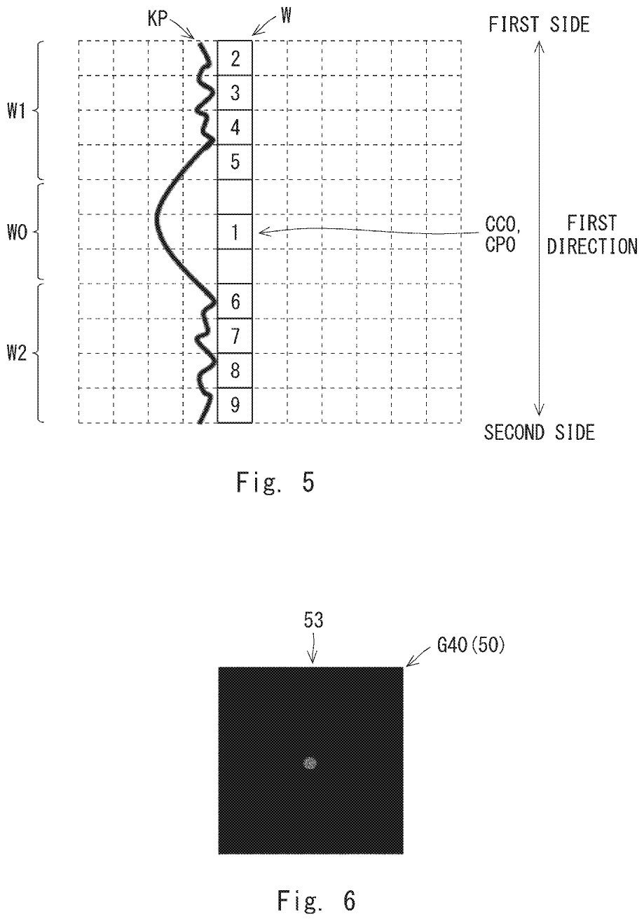

FIG. 5 is a figure illustrating a kernel W used by the determination unit 13, in the inspection apparatus 10 relating to the first embodiment. FIG. 5 also shows a distribution KP of the parameter (luminance) of pixels of the difference image G30 at positions corresponding to respective cells of the kernel W. As shown in FIG. 5, the kernel W includes a plurality of cells arranged in a row in the first direction in which the continuous region 53 extends. The size of individual cells may virtually correspond to the size of pixels of the difference image G30. The kernel W has a center part W0 that includes cells in the center portion, a first peripheral part W1 that includes cells more on a first side in the first direction than the center part W0, and a second peripheral part W2 that includes cells more on a second side in the first direction than the center part W0.

The center part W0 includes one or more cells. The first peripheral part W1 includes two or more cells. The second peripheral part W2 includes two or more cells. As an example, the figure illustrates a kernel W in which the center part W0 includes one cell and the first peripheral part W1 and the second peripheral part W2 each include four cells. The cell of the center part W0 is called a concerned cell CCO. The pixel of the difference image G30 at a position corresponding to the concerned cell CCO is called a concerned pixel CPO. There may be a gap between the concerned cell CCO and the cell on the second side of the first peripheral part W1. There may be a gap between the concerned cell CCO and the cell on the first side of the second peripheral part W2. The size of these gaps may change in accordance with the size of a detected defect. The kernel W functions as a conversion operator that converts the parameter of each pixel of the difference image G30.

A region to which the kernel W is applied in the difference image G30 is called a processing region. There may be cases where the continuous region 53 in the difference image G30 has a range wider than that of the processing region. The determination unit 13 sequentially sets the entire continuous region 53 as a processing region, by applying the kernel W so as to completely sweep the continuous region 53 of the difference image G30. The determination unit 13 converts the parameter of pixels of the difference image G30 into the conversion parameter, by applying the kernel W as the conversion operator to the processing region in the continuous region 53 of the difference image G30. In a case where the parameter of pixels of the difference image G30 includes luminance, the determination unit 13 converts the luminance of the difference image G30 into a conversion luminance.

Hereinafter, a process that converts the parameter of pixels of the difference image G30 to the conversion parameter by the kernel W, which is performed by the determination unit 13, will be described by dividing into a process A, a process B, and a process C. It can also be said that the process that converts the parameter of pixels of the difference image G30 to the conversion parameter is a process that converts the difference image G30 to a conversion image G40, which will be described below.

### (Process A)

The determination unit 13 calculates a statistical value in the parameter (luminance) of pixels of the difference image G13 at positions corresponding to respective cells of the first peripheral part W1 (called a first peripheral region pixel group), by applying the kernel W to the processing region of the difference image G13. Here, a description will be made by using an average value as the statistical value. The statistical value may include at least one of an average value and a standard deviation. A description will be made below for a case where the statistical value includes a standard deviation. As an example, the determination unit 13 calculates an average value in the parameter (luminance) of the first peripheral region pixel group, as a first statistical value, such as shown in the following Formula (1). Moreover, the determination unit 13 calculates a statistical value in the parameter (luminance) of pixels of the difference image G13 at positions corresponding to respective cells of the second peripheral part W2 (called a second peripheral region pixel group), by applying the kernel W to the processing region of the difference image G13. As an example, the determination unit 13 calculates an average value in the parameter (luminance) of the second peripheral region pixel group, as a second statistical value, such as shown in the following Formula (2). Note that, Formula (1) and Formula (2) show the first statistical value by TV_1 and show the second statistical value by TV_2. Moreover, in this example, pixel 2 to pixel 5 are pixels that belong to the first peripheral region pixel group, and pixel 6 to pixel 9 are pixels that belong to the second peripheral region pixel group.

$$TV\_ 1 = parameter ( luminance ) average value of pixel 2 to pixel 5 \qquad ( 1 )$$

$$TV\_ 2 = parameter ( luminance ) average value of pixel 6 to pixel 9 \qquad ( 2 )$$

The determination unit 13 acquires the parameter (luminance) of the pixel (concerned pixel CPO) of the difference image G13 at the position corresponding to the concerned cell CCO in the center part W0 of the kernel W, by applying the kernel W to the processing region of the difference image G13. In the figure, the concerned pixel CPO is shown by pixel 1. The parameter (luminance) of the concerned pixel CPO is called a concerned value. In a case where the luminance is the parameter, it is also called a concerned value. In a case where the center part W0 includes a plurality of cells, the determination unit 13 may calculate a statistical value in the parameter (luminance) of each pixel of the difference image G13 at positions corresponding to respective concerned cells CCO in the center part W0, that is, a statistical value in the parameter (luminance) of the plurality of concerned pixels CPO, as the concerned value.

### (Process B)

The determination unit 13 calculates a first defect signal from the concerned value and the first statistical value. Specifically, the determination unit 13 calculates the first defect signal from a difference between the concerned value and the first statistical value (average value), such as shown in the following Formula (3). Moreover, the determination unit 13 calculates a second defect signal from the concerned value and the second statistical value. Specifically, the determination unit 13 calculates the second defect signal from a difference between the concerned value and the second statistical value (average value), such as shown in the following Formula (4). Note that, Formula (3) and Formula (4) show the first defect signal by KS_1, show the second defect signal by KS_2, and show the concerned value by CV.

$$KS\_ 1 = CV - TV\_ 1 \qquad ( 3 )$$

$$KS\_ 2 = CV - TV\_ 2 \qquad ( 4 )$$

### (Process C)

The determination unit 13 converts the concerned value in the center region in the difference image G30, based on a condition satisfied by the first defect signal and the second defect signal. For example, the determination unit 13 converts the luminance (concerned value) of the concerned pixel CPO into a conversion luminance, based on a condition satisfied by the first defect signal and the second defect signal. Specifically, in a case where both of condition I and condition II are satisfied, the determination unit 13 converts the parameter (luminance) of the concerned pixel CPO into a defect signal sum. Condition II uses Formula (5) and Formula (6). The defect signal sum is a sum of the first defect signal and the second defect signal, such as calculated in Formula (7). Formula (7) shows the defect signal sum by KSW.

In a case where at least one of condition I and condition II is not satisfied, the determination unit 13 replaces the parameter (luminance) of the concerned pixel CPO in the center region in the difference image G30 with a specific value. The specific value may be a predetermined luminance, for example, 0.

### [Condition I]

The sign of the first defect signal (KS_1) and the sign of the second defect signal (KS_2) are equal to each other.

### [Condition II]

Both the first defect signal and the second defect signal are large to the same extent. That is, an absolute value of the first defect signal is larger than a value obtained by dividing an absolute value of the second defect signal by a number L larger than 1, such as shown in Formula (5). An absolute value of the second defect signal is larger than a value obtained by dividing an absolute value of the first defect signal by a number L larger than 1, such as shown in Formula (6). Note that, in Formula (5) and Formula (6), L is a number larger than 1. Lis, for example, 4. Moreover, |KS_1| and |KS_2| respectively show an absolute value of the first defect signal (KS_1) and an absolute value of the second defect signal (KS_2).

$$\vert KS\_ 1 \vert > ( \vert KS\_ 2 \vert / L ) \qquad ( 5 )$$

$$\vert KS\_ 2 \vert > ( \vert KS\_ 1 \vert / L ) \qquad ( 6 )$$

$$KSW = KS\_ 1 + KS\_ 2 \qquad ( 7 )$$

The determination unit 13 performs a process that applies the kernel W to each pixel of the continuous region 53 in the difference image G30, and outputs a pixel value after processing. The determination unit 13 sweeps the entire continuous region 53 with the kernel W, by gradually modifying the pixel (concerned pixel CPO) of the difference image G13 at the position corresponding to the concerned cell CCO of the kernel W. In this way, the determination unit 13 converts the parameter of the pixel of the difference image G30 to the conversion parameter (conversion luminance), for the entire continuous region 53. More specifically, the determination unit 13 converts the parameter of the pixel of the continuous region 53 in the difference image G30 into the defect signal sum KSW or the specific value (for example, 0).

Note that, in the above explanations, while in a case where both of condition I and condition II are satisfied, the determination unit 13 converts the parameter (luminance) of the concerned pixel CPO into the defect signal sum, and in a case where at least one of condition I and condition II is not satisfied, the determination unit 13 replaces the parameter (luminance) of the concerned pixel CPO with the specific value, the present disclosure is not limited to this. That is, in a case where condition I is satisfied, the determination unit 13 may convert the parameter (luminance) of the concerned pixel CPO into the defect signal sum, and in a case where condition I is not satisfied, the determination unit 13 may replace the parameter (luminance) of the concerned pixel CPO with the specific value. Or, in a case where condition II is satisfied, the determination unit 13 may convert the parameter (luminance) of the concerned pixel CPO into the defect signal sum, and in a case where condition II is not satisfied, the determination unit 13 may replace the parameter (luminance) of the concerned pixel CPO with the specific value. Or, in a case where at least one of condition I and condition II is satisfied, the determination unit 13 may convert the parameter (luminance) of the concerned pixel CPO into the defect signal sum, and in a case where both of condition I and condition II are not satisfied, the determination unit 13 may replace the parameter (luminance) of the concerned pixel CPO with the specific value.

The determination unit 13 may convert the difference image G30 into the conversion image, by applying the kernel W to the difference image G30. The conversion image includes the conversion parameter (conversion luminance), in which the parameter (luminance) of each pixel of the continuous region 53 in the difference image G30 is converted, in each pixel. FIG. 6 is a figure illustrating the conversion image G40 of the sample 50, in the inspection apparatus 10 relating to the first embodiment. As shown in FIG. 6, the conversion image G40 is an image in which, for example, M pixels are arranged in a row in the first direction, similar to the difference image G30, and, for example, N pixels are arranged in a row in the second direction. A parameter I'm, n in each pixel (p′m,n) of the conversion image G40 is modified from a parameter Im, n of each pixel (pm,n) of the difference image G30 to the defect signal sum KSW or the specific value (for example, 0), by the application of the kernel W.

The determination unit 13 determines a defect, based on the conversion parameter. For example, the determination unit 13 determines that a portion where the conversion parameter (conversion luminance) of pixels in the conversion image G40 has a value of a predetermined range (for example, equal to or larger than a threshold) is a defect. In this way, the determination unit 13 determines a defect, in a predetermined processing region within a region corresponding to the continuous region 53, based on a parameter based on the difference image G30 in the center region, a parameter based on the difference image G30 in the first peripheral region, and a parameter based on the difference image G30 in the second peripheral region.

According to the above explanations, it can be said that the determination unit 13 determines a defect in the center region, based on the first defect signal (KS_1) in which the parameter of pixels of the difference image G30 in the center region is corrected based on the first statistical value of the parameter of pixels of the difference image G30 of the first peripheral region, and the second defect signal (KS_2) in which the parameter of pixels of the difference image G30 in the center region is corrected based on the second statistical value of the parameter of pixels of the difference image G30 of the second peripheral region. Moreover, it can be said that the determination unit 13 determines a defect in the center region, based on a condition related to the first defect signal (KS_1) and the second defect signal (KS_2). Specifically, the determination unit 13 determines a defect in the center region, along with the conversion parameter in which the parameter of pixels of the difference image G30 in the center region is converted, based on a condition related to the first defect signal (KS_1) and the second defect signal (KS_2). Note that, a condition related to the first defect signal (KS_1) and the second defect signal (KS_2) may include at least one of the above described condition I and condition II.

### (Statistical Value)

As described above, the first statistical value and the second statistical value may respectively be an average value of the parameter (luminance) of the first peripheral region pixel group (pixel 2 to pixel 5) and an average value of the parameter (luminance) of the second peripheral region pixel group (pixel 6 to pixel 9). However, in a case where the statistical value is an average value, there may be cases where a profile of the parameter (luminance) of the first peripheral region and a profile of the parameter (luminance) of the second peripheral region are unable to be successfully expressed, due to variations of the parameter (luminance). For example, in a case where there is a singular point of very high luminance or very low luminance compared to other portions, such as spike noise or the like, an average value strongly receives an influence of the value of such a singular point. Accordingly, the first defect signal and the second defect signal also strongly receive an influence of the value of such a singular point.

Accordingly, in the present embodiment, the determination unit 13 may calculate a standard deviation, in addition to an average value, as the statistical value. The determination unit 13 may use the standard deviation, such as shown in Formula (8) and Formula (9), when calculating the first defect signal and the second defect signal.

$$KS\_ 1 = ( CV - TV\_ 1 ) / σ\_ 1 \qquad ( 8 )$$

$$KS\_ 2 = ( CV - TV\_ 2 ) / σ\_ 2 \qquad ( 9 )$$

Here, σ_1 and σ_1 respectively show a standard deviation of the parameter (luminance) of the first peripheral region pixel group and a standard deviation of the parameter (luminance) of the second peripheral region pixel group. In this way, in a case where there is a singular point or the like, the first defect signal and the second defect signal appropriately reflect a luminance distribution of the first peripheral region and a luminance distribution of the second peripheral region.

### (Different Kernel)

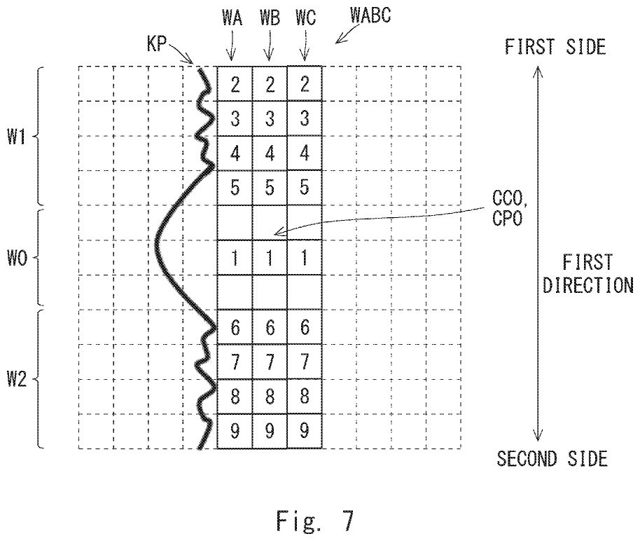

FIG. 7 is a figure illustrating a different kernel WABC used by the determination unit 13, in the inspection apparatus 10 relating to the first embodiment. As shown in FIG. 7, the kernel WABC may have each cell of the kernel W arranged in a plurality of rows in a direction orthogonal to the first direction. For example, as illustrated in FIG. 7, the kernel WABC may have each cell of the kernel W arranged in 3 rows in a direction orthogonal to the first direction. The kernel WABC includes a sub-kernel WA, a sub-kernel WB, and a sub-kernel WC. The sub-kernel WA, the sub-kernel WB, and the sub-kernel WC are each equivalent to the kernel W.

The determination unit 13 calculates a first statistical value (TVA_1, TVB_1, and TVC_1) and a second statistical value (TVA_2, TVB_2, and TVC_2), by Formula (1) and Formula (2), in each of the sub-kernel WA, the sub-kernel WB, and the sub-kernel WC in the kernel WABC.

The determination unit 13 calculates a first defect signal (KSA_1, KSB_1, and KSC_1) and a second defect signal (KSA_2, KSB_2, and KSC_2), by Formula (3) and Formula (4), in each of the sub-kernel WA, the sub-kernel WB, and the sub-kernel WC in the kernel WABC.

The determination unit 13 converts the parameter of the concerned pixel CPO corresponding to the center part of the kernel WABC (in a case where a plurality of sub-kernels are arranged in a row in a direction orthogonal to the first direction, it may be a pixel of the center part of a sub-kernel in the center (sub-kernel WB)), based on [condition I] and [condition II], in each of the sub-kernel WA, the sub-kernel WB, and the sub-kernel WC in the kernel WABC. For example, in a case where both of [condition I] and [condition II] are satisfied, in each of the sub-kernel WA, the sub-kernel WB, and the sub-kernel WC in the kernel WABC, the determination unit 13 converts the concerned pixel CPO of the difference image G30 at the position corresponding to the concerned cell CCO in the center part of the kernel WB into a defect signal sum (KSWABC) such as shown in the following Formula (10).

KSWABC=KSA_1+KSA_2+KSB_1+KSB_2+KSC_1+KSC_2+ (10)

In a case where at least one of [condition I] and [condition II] is not satisfied, in at least one of the sub-kernel WA, the sub-kernel WB, and the sub-kernel WC in the kernel WABC, the determination unit 13 converts the concerned pixel CPO into the specific value (for example, 0).

### (Information Processing Apparatus)

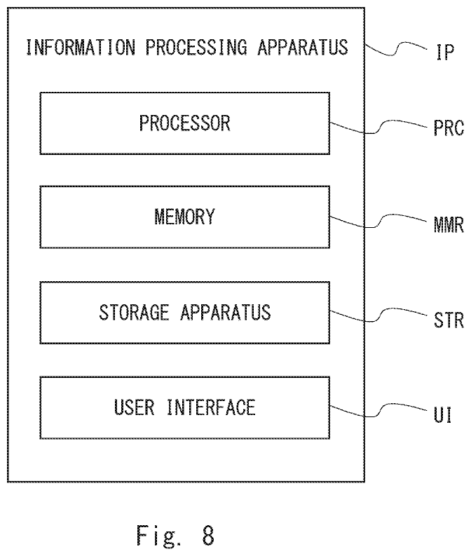

FIG. 8 is a block diagram illustrating an information processing apparatus IP relating to the first embodiment. As shown in FIG. 8, the inspection apparatus 10 may include, for example, the information processing apparatus IP that includes a computer such as a microprocessor, a server, or a personal computer.

The information processing apparatus IP may include a processor PRC, a memory MMR, a storage apparatus STR, and a user interface UI. The storage apparatus STR programs and stores processes executed by each configuration of the inspection apparatus 10. Moreover, the processor PRC causes a program from the storage apparatus STR to be read to the memory MMR, and executes this program. In this way, the processor PRC implements the functions of each configuration in the inspection apparatus 10. The user interface UI may include an input apparatus such as a keyboard, a mouse, or an imaging apparatus, and an output apparatus such as a display, a printer, or a speaker.

The information processing apparatus IP includes at least one memory MMR that stores a command group, and at least one processor PRC. The processor PRC, by executing the command group, specifies the continuous region 53 in which a substantially equivalent predetermined property is continuous in the first direction, in the sample 50 in which the pattern 51 is formed. Moreover, the processor PRC, by executing the command group, acquires the difference image G30 based on a comparison between the captured image G10 and the reference image G20. In addition, the processor PRC, by executing the command group, determines a defect, in a predetermined processing region within the continuous region 53, based on a parameter based on the difference image G30 in the center region, a parameter based on the difference image G30 in the first peripheral region, and a parameter based on the difference image G30 in the second peripheral region. The processor PRC may be configured so as to execute such a command group.

Each configuration of the information processing apparatus IP may be respectively implemented by dedicated hardware. Moreover, a part or the entirety of each constituent element may be implemented by a general-purpose or dedicated circuit (circuitry), processor PRC or the like, or a combination of these. These may be configured by a single chip, or may be configured by a plurality of chips connected via a bus. A part or the entirety of each constituent element may be implemented by a combination of the above described circuit or the like and a program. Moreover, a CPU, GPU, FPGA (Field-programmable Gate Array), quantum processor (quantum computer control chip) or the like can be used as the processor PRC.

Moreover, in a case where a part or the entirety of each constituent element of the information processing apparatus IP is implemented by a plurality of information processing apparatuses IP, circuits or the like, the plurality of information processing apparatuses IP, circuits or the like may be centrally arranged, or may be distributed. For example, the information processing apparatuses IP, circuits or the like may be implemented in a form where each one is connected via a communication network, by a client server system, cloud computing system or the like. Moreover, the functions of the information processing apparatuses IP may be provided in a Saas (Software as a Service) format.

### (Inspection Method)

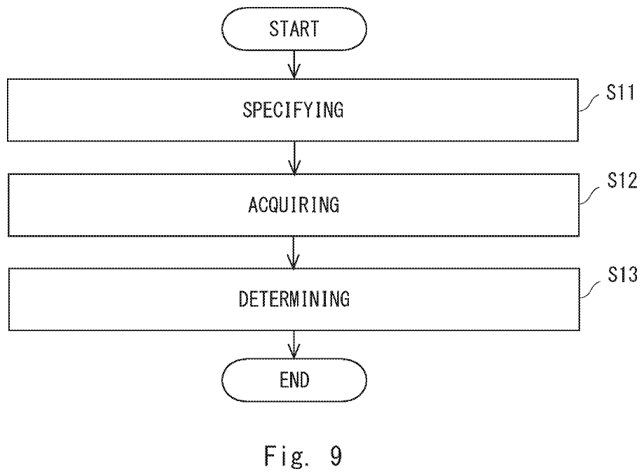

Next, an inspection method relating to the present embodiment will be described. FIG. 9 is a flowchart diagram illustrating an inspection method relating to the first embodiment. As shown in FIG. 9, the inspection method of the present embodiment includes a step S11 of specifying, a step S12 of acquiring, and a step S13 of determining. The step S12 of acquiring may be performed prior to the step S11 of specifying, or may be performed in parallel with the step S11 of specifying.

In step S11, the specification unit 11 specifies the continuous region 53 in which a substantially equivalent predetermined property is continuous in the first direction, in the sample 50 in which the pattern 51 is formed.

In step S12, the acquisition unit 12 acquires the difference image G30 based on a comparison between the captured image G10 and the reference image G20 of the sample 50.

In step S13, the determination unit 13 determines a defect, in a predetermined processing region within the continuous region 53 in the difference image G30, based on a parameter based on the difference image G30 in the center region, a parameter based on the difference image G30 in the first peripheral region, and a parameter based on the difference image G30 in the second peripheral region.

Specifically, in step S13, the determination unit 13 first generates a first defect signal from the parameter (luminance) of the concerned pixel CPO and the first statistical value of the first peripheral region pixel group. Moreover, the determination unit 13 generates a second defect signal from the luminance of the concerned pixel CPO and the second statistical value of the second peripheral region pixel group. The determination unit 13 converts the parameter (luminance) of the concerned pixel CPO into the conversion parameter (conversion luminance), based on condition I and condition II in which the first defect signal and the second defect signal are satisfied. In this way, the determination unit 13 determines a defect, based on the converted conversion parameter (conversion luminance). The determination unit 13 may determine a defect, in a case where the conversion parameter in the conversion image G40 is a value of a predetermined range (for example, a value equal to or larger than a threshold).

Next, the effect of the present embodiment will be described. The inspection apparatus 10 of the present embodiment determines a defect, based on a parameter based on the difference image G30 in the center region, a parameter based on the difference image G30 in the first peripheral region, and a parameter based on a difference image G30 in the second peripheral region. Accordingly, since an afterimage or the like appearing in the captured image G10 or the reference image G20 can be differentiated, a detection accuracy of a defect can be improved. It can be said that the inspection apparatus 10 of the present embodiment determines a defect from a relationship between a portion that becomes a candidate for a defect and a peripheral region in the difference image G30, in addition to determining a defect candidate from an image appearing in the difference image G30 as a defect (or, instead of this), based on the configuration described above. In particular, the inspection apparatus 10 attaches importance to a balance between a parameter of a first side and a parameter of a second side in the portion that becomes a candidate for a defect, in the continuous region 53 in which a substantially equivalent predetermined property is continuous in the first direction. That is, for a defect in the continuous region 53, a defect is determined based on condition I and condition II in which a parameter of a first side and a parameter of a second side are satisfied. In this way, a detection accuracy of a defect can be improved.

### Second Embodiment

Next, an inspection apparatus relating to a second embodiment will be described. In the inspection apparatus of the present embodiment, the specification unit 11 specifies a defect candidate region based on the difference image G30. The determination unit 13 sets a region within the continuous region 53 that includes the defect candidate region as a processing region. While the parameter of pixels is described as luminance, the parameter may be a parameter other than luminance.

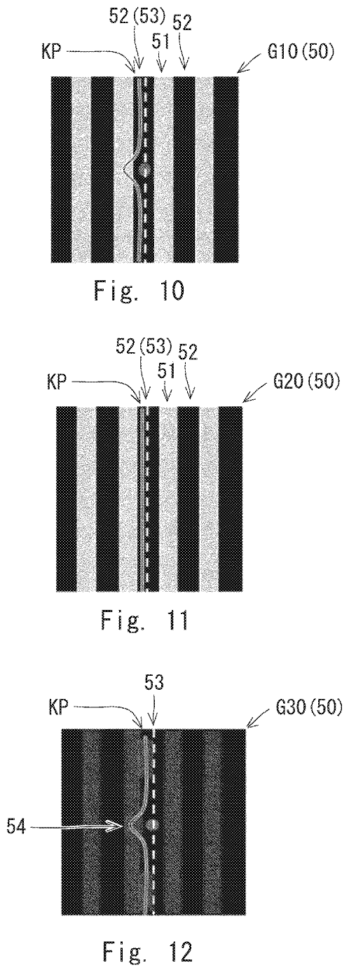

FIG. 10 is a figure illustrating the captured image G10 of the sample 50, in the inspection apparatus 10 relating to the second embodiment. FIG. 11 is a figure illustrating the reference image G20 of the sample 50, in the inspection apparatus 10 relating to the second embodiment. FIG. 12 is a figure illustrating the difference image G30 of the sample 50, in the inspection apparatus 10 relating to the second embodiment. A luminance profile KP in the continuous region 53 is shown in each figure.

As shown in FIG. 10, the captured image G10 has a parameter distribution in which the parameter changes along the first direction, in the continuous region 53. Hereinafter, a description will be made by using the luminance profile KP in which the luminance changes along the first direction, as the parameter distribution. For example, the luminance profile KP in the captured image G10 has a high luminance portion that includes a pixel with a luminance higher than a predetermined threshold. On the other hand, as shown in FIG. 11, in the luminance profile KP of the reference image G10, a portion corresponding to the high luminance portion in the captured image G10 has a flat luminance profile KP. Therefore, as shown in FIG. 12, the luminance profile KP of the difference image GO has a high luminance portion in the portion corresponding to the high luminance portion in the captured image G10.

The determination unit 13 acquires the luminance profile KP along the first direction, in the continuous region 53 in the difference image G30. The determination unit 13 specifies the defect candidate region 54 from the acquired luminance profile KP. For example, the determination unit 13 specifies the defect candidate region 54 that includes pixels having the parameter (luminance) within a predetermined range (for example, equal to or larger than a predetermined threshold) in the difference image G30. The defect candidate region 54 corresponds to the high luminance portion in the captured image G10.

In this case, the determination unit 13 sets a region that includes the defect candidate region 54 as a processing region. Specifically, the determination unit 13 may apply the kernel W, in the processing region within the continuous region 53 that includes the defect candidate region 54.

According to the present embodiment, since the kernel W is applied only to the continuous region 53 that includes the specified defect candidate region 54 based on the difference image G30, the processing time can be shortened.

Note that, the determination unit 13 may perform a process other than applying the kernel W, in the processing region within the continuous region 53 that includes the defect candidate region 54. For example, the determination unit 13 specifies the defect candidate region 54 within the continuous region 53 from a luminance profile of the difference image G30. The determination unit 13 may perform the above described processes of (process A), (process B), and (process C), by setting the defect candidate region 54 as a center region, setting a region more on a first side in the first direction than the defect candidate region 54 as a first peripheral region, and setting a region more on a second side in the first direction than the defect candidate region 54 as a second peripheral region.

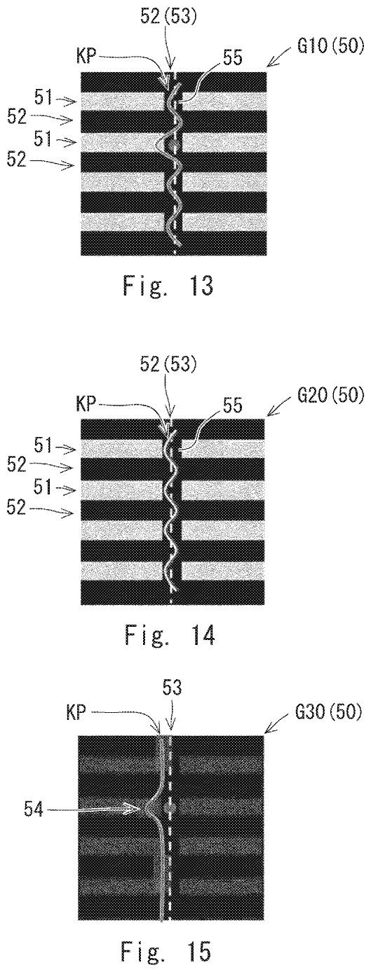

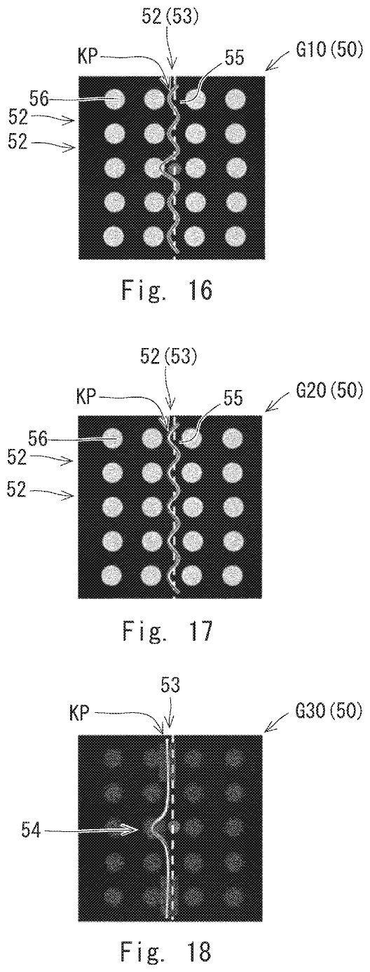

FIG. 13 is a figure illustrating the captured image G10 of the sample 50, in the inspection apparatus 10 relating to the second embodiment. FIG. 14 is a figure illustrating the reference image G20 of the sample 50, in the inspection apparatus 10 relating to the second embodiment. FIG. 15 is a figure illustrating the difference image G30 of the sample 50, in the inspection apparatus 10 relating to the second embodiment.

As shown in FIG. 13 to FIG. 15, the sample 50 may have a plurality of patterns 51 that extend in a second direction intersecting the first direction. The second direction may be orthogonal to the first direction. The plurality of patterns 51 may include portions arranged in a row in the second direction. For example, a group in which two of the patterns 51 are arranged in a row in the second direction may have a gap portion 55 between the two patterns 51. The sample 50 may have a plurality of such groups arranged spaced apart in the first direction. In a case where there are a plurality of groups, the plurality of gap portions 55 are arranged in a row spaced apart in the first direction. A portion where there is no pattern 51 in the sample 50 is a pattern interval 52. Accordingly, the pattern interval 52 includes the gap portion 55. Therefore, the pattern interval 52 that includes a region in which the plurality of gap portions 55 are arranged in a row spaced apart in the first direction becomes the continuous region 53. The sample 50 may include a defect in the gap portion 55.

Note that, the pattern 51 of the sample 50 may be replaced by the pattern interval 52. In this case, the pattern interval 52 is replaced by the pattern 51. Accordingly, the pattern 51 includes the gap portion 55. The pattern 51 that includes a region in which the plurality of gap portions 55 are arranged in a row spaced apart in the first direction becomes the continuous region 53. The sample 50 may include a defect in the gap portion 55.

In this way, the sample 50 may have one or more groups in which two of the patterns 51 extending in the second direction intersecting the first direction or two of the pattern intervals 52 extending in the second direction intersecting the first direction are adjacent in the second direction with the gap portion 55 interposed therebetween. In a case where there are a plurality of groups in the sample 50, the plurality of groups may be arranged in a row spaced apart in the first direction. The continuous region 53 may include one or more of the gap portions 55 arranged in a row in the first direction.

There may be cases where pixels of the gap portion 55 in the captured image G10 and the reference image G20 have a high luminance compared to other portions. For example, there may be cases where the luminance of pixels of the gap portion 55 becomes a high luminance, due to the influence of an afterimage at the time when captured. Therefore, if it is determined that a portion of high luminance in the captured image G10 is a defect, such an afterimage that is not originally a defect is incorrectly determined to be a defect.

Moreover, there is a difficulty in having the difference image G30 that differentiates between the captured image G10 and the reference image G20 completely cancel out the influence of an afterimage. For example, there may be cases where the influence of an afterimage remains due to a difference between a condition such as light intensity, viewing angle, or magnification at the time of capturing the captured image G10 and a condition such as light intensity, viewing angle, or magnification at the time of capturing the reference image G20.

The inspection apparatus 10 of the present embodiment determines a defect, based on a parameter based on the difference image G30 in the center region, a parameter based on the difference image G30 in the first peripheral region, and a parameter based on the difference image G30 in the second peripheral region, such as described above. In a case where a defect is present in the continuous region 53, the inspection apparatus 10 determines a defect based on condition I and condition II in which a parameter of a first side and a parameter of a second side are satisfied. In this way, a detection accuracy of a defect can be improved.

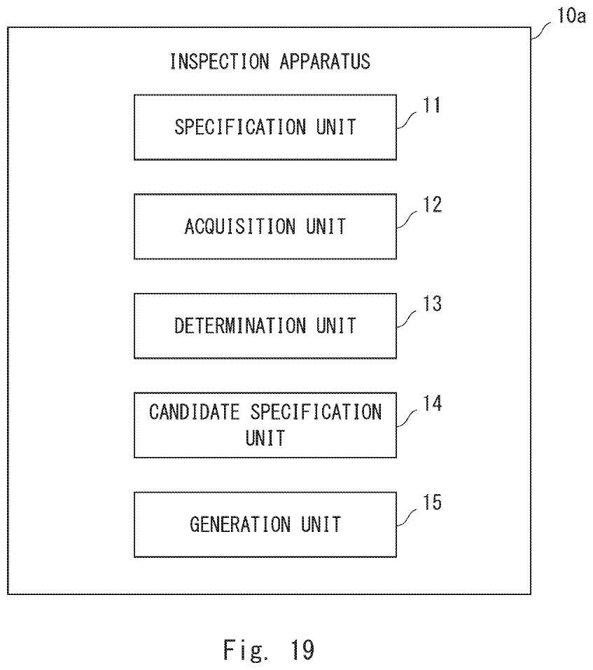

FIG. 16 is a figure illustrating the captured image G10 of the sample 50, in the inspection apparatus 10 relating to the second embodiment. FIG. 17 is a figure illustrating the reference image G20 of the sample 50, in the inspection apparatus 10 relating to the second embodiment. FIG. 18 is a figure illustrating the difference image G30 of the sample 50, in the inspection apparatus 10 relating to the second embodiment.

As shown in FIG. 16 to FIG. 18, the sample 50 may have a plurality of circular patterns 56 arranged in a row with the gap portion 55 interposed therebetween in the second direction intersecting the first direction. Here, circular includes not only strictly a circular shape, but also a circular shape in a range that includes manufacturing errors when manufacturing the pattern 51. Moreover, circular also includes a rectangular shape with no difference between the length of the first direction and the length of the second direction, and a rounded rectangular shape with the corner parts of this rectangular shape rounded. A shape with a difference between the length of the first direction and the length of the second direction is included in the above described pattern 51 or pattern interval 52.

The sample 50 may have one or more groups of the plurality of circular patterns 56 arranged in a row with the gap portion 55 interposed therebetween in the second direction. In a case where there are a plurality of groups in the sample 50, a plurality of the plurality of groups may be arranged spaced apart in the first direction. In a case where there are a plurality of groups, the plurality of gap portions 55 are arranged in a row spaced apart in the first direction. A portion where there is no pattern 56 in the sample 50 is the pattern interval 52. Accordingly, the pattern interval 52 includes the gap portion 55. Therefore, the pattern interval 52 that includes a region in which the plurality of gap portions 55 are arranged in a row spaced apart in the first direction becomes the continuous region 53. The sample 50 may include a defect in the gap portion 55.

Note that, the pattern 56 of the sample 50 may be replaced by the pattern interval 52. In this case, the pattern interval 52 is replaced by the pattern 56. Accordingly, the pattern 56 includes the gap portion 55. The pattern 56 that includes a region in which the plurality of gap portions 55 are arranged in a row spaced apart in the first direction becomes the continuous region 53. The sample 50 may include a defect in the gap portion 55.

In the case of FIG. 16 to FIG. 18, an afterimage of the gap portion 55 becomes a problem, similar to FIG. 13 to FIG. 15. However, the inspection apparatus 10 of the present embodiment determines a defect based on condition I and condition II in which a parameter on a first side and a parameter on a second side are satisfied. In this way, a detection accuracy of a defect can be improved.

### Third Embodiment

Next, an inspection apparatus relating to a third embodiment will be described. The inspection apparatus of the present embodiment performs a determination of a defect, without it being essential to use the kernel W. For example, the determination unit 13 may determine a defect in the center region, based on a first defect signal in which the parameter of pixels of the difference image G30 in the center region is corrected based on a first statistical value of the parameter of pixels of the difference image G30 in the first peripheral region, and a second defect signal in which the parameter of pixels of the difference image G30 in the center region is corrected based on a second statistical value of the parameter of pixels of the difference image G30 in the second peripheral region. Here, for example, the first defect signal in which the parameter of pixels of the difference image G30 in the center region is corrected based on a first statistical value of the parameter of pixels of the difference image G30 in the first peripheral region is not limited to a first defect signal in which the parameter of pixels of the difference image G30 in the center region is differentiated by a first statistical value of the parameter of pixel of the difference image G30 in the first peripheral region, such as described above, and includes a first defect signal for which a process other than differentiation, such a taking a ratio, is performed. This is the same for the second defect signal.

The determination unit 13 may determine a defect in the center region, based on a first condition that includes a sign of the first defect signal and a sign of the second defect signal having a predetermined relationship. Moreover, the determination unit 13 may determine a defect in the center region, based on a second condition that includes both of the first defect signal and the second defect signal having a large value to the same extent. The determination unit 13 may determine a defect in the center region, in a case where both a first condition that includes a sign of the first defect signal and a sign of the second defect signal having a predetermined relationship, and a second condition that includes both of the first defect signal and the second defect signal having a large value to the same extent, are satisfied.

In addition, an example that specifies a defect candidate without it being essential to use the kernel W, and performs a determination of authenticity of the defect candidate, will be described by referring to the figures. FIG. 19 is a block diagram illustrating an inspection apparatus 10a relating to the third embodiment. As shown in FIG. 19, the inspection apparatus 10a includes a candidate specification unit 14 and a generation unit 15, in addition to the specification unit 11, the acquisition unit 12, and the determination unit 13. The functions of the specification unit 11 and the acquisition unit 12 are the same as the functions of the specification unit 11 and the acquisition unit 12 in the above described inspection apparatus 10. Note that, the determination unit 13 may have the functions of the candidate specification unit 14 and the generation unit 15.

The candidate specification unit 14 specifies a defect candidate on the continuous region 53, based on the difference image G30. The candidate specification unit 14 may specify a defect candidate, as the above described defect candidate region. For example, the candidate specification unit 14 specifies a defect candidate that includes a pixel having a parameter equal to or larger than a predetermined threshold in the difference image G30. The defect candidate also corresponds to a high luminance portion in the captured image G10.

The generation unit 15 generates a parameter distribution of the difference image G30 along the first direction, for at least a part of the continuous region 53 to which the defect candidate belongs. The parameter distribution may include the above described luminance profile KP. The generation unit 15 may generate the parameter distribution for a peripheral region different from the defect candidate in the continuous region 53, based on a statistical value of the parameter of the difference image G30 in this peripheral region.

The peripheral region may include the above described first peripheral region and second peripheral region. The statistical value may include an average value. Note that, the statistical value may include at least one of an average value and a standard deviation. The generation unit 15 may generate a parameter distribution for the peripheral region different from the defect candidate in the continuous region 53, based on the statistical value of the parameter of the difference image G30 in this peripheral region, by performing the processes of the above described Formula (1) and Formula (2).

The generation unit 15 may generate the parameter distribution for the defect candidate region that includes the defect candidate, based on a difference between the parameter of the difference image G30 in the defect candidate region and the statistical value. For example, the parameter distribution for the defect candidate region that includes the defect candidate may include the above described first defect signal and second defect signal. The generation unit 15 may generate the parameter distribution for the defect candidate region that includes the defect candidate, based on a difference between the parameter of the difference image G30 in the defect candidate region and the statistical value, by performing the processes of the above described Formula (3) and Formula (4).

The determination unit 13 determines authenticity for the defect candidate, based on the parameter distribution. Specifically, the determination unit 13 determines whether or not there is a peak value that satisfies a predetermined condition, based on the parameter distribution for the generated defect candidate region. Here, the predetermined condition may include a condition that a difference between the parameter of the difference image G30 in the defect candidate region and the statistical value has a predetermined amount. Moreover, the predetermined condition may include a condition that a first difference value, which is a difference value between the parameter of the difference image G30 in the defect candidate region and the statistical value of the parameter of the difference image G30 for the first peripheral region that is on a first side of the first direction with respect to the defect candidate, within peripheral regions different from the defect candidate in the continuous region 53, and a second difference value, which is a difference value between the parameter of the difference image G30 in the defect candidate region and the statistical value of the parameter of the difference image for the second peripheral region that is on a second side of the first direction with respect to the defect candidate, within peripheral regions different from the defect candidate in the continuous region 53, match each other to a predetermined extent. The first difference value and the second difference value may correspond to the above described first defect signal and second defect signal. That is, the determination unit 13 may determine authenticity of the defect candidate, based on condition I and condition II, by setting the first difference value and the second difference value as the above described first defect signal and second defect signal. Moreover, the predetermined condition may further include a condition that a conversion parameter, in which the parameter of pixels of the defect candidate (that is, the difference image G30 in the center region) is converted based on the above described Formula (10), is a value of a predetermined range (for example, equal to or larger than a threshold).

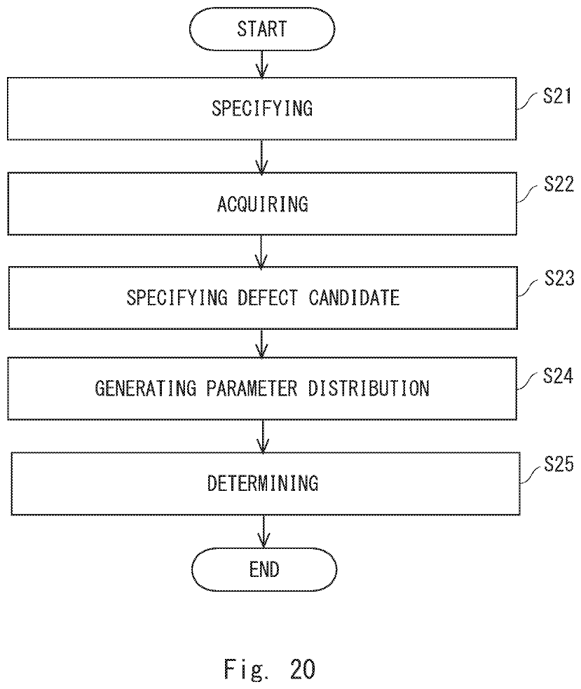

FIG. 20 is a flowchart diagram illustrating an inspection method relating to the third embodiment. As shown in FIG. 20, the inspection method of the present embodiment includes a step S23 of specifying a defect candidate and a step S24 of generating a parameter distribution, in addition to the step S21 of specifying, the step S22 of acquiring, and the step S25 of determining. The step S21 of specifying and the step S22 of acquiring are the same as the above described step S11 of specifying and step S12 of acquiring.

In step S23, the candidate specification unit 14 specifies a defect candidate on the continuous region 53, based on the difference image G30. For example, the candidate specification unit 14 specifies the defect candidate that includes a pixel having a parameter equal to or larger than a predetermined threshold in the difference image G30.

In step S24, the generation unit 15 generates a parameter distribution of the difference image G30 along the first direction, for at least a part of the continuous region 53 to which the defect candidate belongs.

In step S25, the determination unit 13 determines authenticity for the defect candidate, based on the parameter distribution. The determination unit 13 determines whether or not there is a peak value satisfying a predetermined condition, based on the parameter distribution. In such a way, the inspection apparatus 10a of the present embodiment can perform a determination of a defect, even if not using the kernel W.

### Fourth Embodiment

Next, an optical apparatus relating to a fourth embodiment will be described. The optical apparatus of the present embodiment includes the inspection apparatus 10 or the inspection apparatus 10a. The inspection apparatus 10 and the inspection apparatus 10a will be collectively called an inspection apparatus 10. The optical apparatus includes, for example, the inspection apparatus 10 and an apparatus that inspects the sample 50 by an optical technique. Moreover, the optical apparatus may include the inspection apparatus 10 and a review apparatus that reviews the sample 50. Hereinafter, as an example of the optical apparatus, a description will be made by calling an apparatus that includes the inspection apparatus 10 and the apparatus that inspects the sample 50 by an optical technique an inspection apparatus 100.

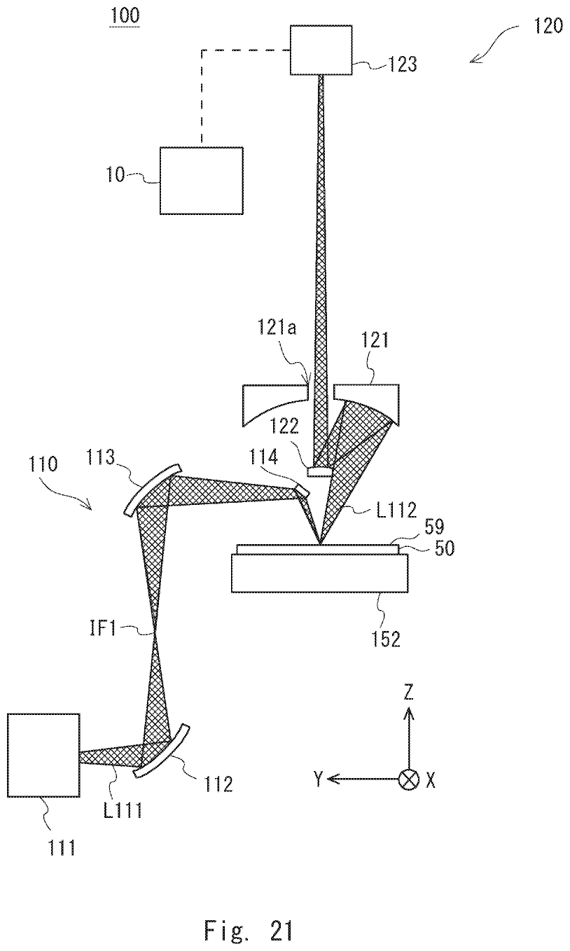

FIG. 21 is a configuration diagram illustrating the inspection apparatus 100 relating to the fourth embodiment. The inspection apparatus 100 includes an illumination optical system 110, an imaging optical system 120, and the inspection apparatus 10. The illumination optical system 110 illuminates the sample 50, by using illumination light L111. The sample 50 is, for example, a mask having a pattern 51. Note that, the sample 50 is not limited to a mask, as long as it has the pattern 51, and may be a semiconductor substrate, a semiconductor chip or the like. The illumination optical system 110 has, for example, a light source 111, a spheroidal mirror 112, a spheroidal mirror 113, and an inset mirror 114.

The imaging optical system 120 captures a captured image G10 of the sample 50 illuminated by the illumination light L111. The imaging optical system 120 has, for example, a perforated concave mirror 121, a convex mirror 122, and a detector 123. The perforated concave mirror 121 and the convex mirror 122 constitute a Schwarzschild magnification optical system. Note that, the illumination optical system 110 and the imaging optical system 120 may further include optical members other than those described above, and any one of the above described optical members may be omitted.

Here, for convenience of the explanation of the inspection apparatus 100, an XYZ cartesian coordinate system will be introduced. For example, a plane parallel to a stage plane of a stage 152 on which the sample 50 is arranged is set as an XY plane, and a direction orthogonal to the stage plane is set as a Z-axis direction. For convenience, the +Z-axis direction is called above and the −Z-axis direction is called below. Note that, above and below are for convenience of the explanation of the inspection apparatus 100, and do not show the actual directions in which the inspection apparatus 100 is arranged.

The light source 111 generates the illumination light L111. The illumination light L111 includes, for example, EUV light of 13.5 nm that is the same as an exposure wavelength of an EUV mask, which is the sample 50. The illumination light L111 generated from the light source 111 is reflected by the spheroidal mirror 112. The illumination light L111 reflected by the spheroidal mirror 112 advances while converging, and is focused at a focusing point IF1. The focusing point IF1 is arranged at a position conjugate to a pattern surface 59 of the sample 50.

The illumination light L111, after passing through the focusing point IF1, advances while diverging, and is made incident on a reflection mirror such as the spheroidal mirror 113. The illumination light L111 made incident on the spheroidal mirror 113 is reflected by the spheroidal mirror 113, advances while converging, and is made incident on the inset mirror 114. That is, the spheroidal mirror 113 causes the illumination light L111 to be made incident on the inset mirror 114 as convergent light. The inset mirror 114 is arranged above the sample 50. The illumination light L111 made incident on and reflected by the inset mirror 114 is made incident on the sample 50. That is, the inset mirror 114 causes the illumination light L111 to be made incident with respect to the sample 50.

The spheroidal mirror 113 focuses the illumination light L111 on the sample 50. The illumination optical system 110 is installed so that an image of the light source 111 is imaged on the pattern surface 59 of the sample 50, when the illumination light L111 illuminates the sample 50. Accordingly, the illumination optical system 110 has a critical illumination. In this way, the illumination optical system 110 illuminates the sample 50 by using the critical illumination from the illumination light L111 generated in the light source 111.

The sample 50 is arranged on the stage 152. The illumination light L111 is made incident on the sample 50 from a direction inclined from the Z-axis direction. That is, the illumination light L111 is made incident obliquely at an angle with respect to the sample 50, as oblique incident illumination. The illumination light L111 may illuminate the sample 50, as such oblique incident illumination.

The stage 152 is an XYZ drive stage. A desired region of the sample 50 can be illuminated, by moving the stage 152 in an X-axis direction and a Y-axis direction. In addition, a focus adjustment can be performed, by moving the stage 152 in the Z-axis direction. Moreover, the stage 152 may be rotated by setting each of the X-axis, the Y-axis, and the Z-axis as a rotation axis. Note that, instead of moving or rotating the stage 152 along the X-axis direction, the Y-axis direction, and the Z-axis direction, the illumination optical system 110 and the imaging optical system 120 may be moved and rotated.

The illumination light Llll from the light source 111 illuminates an imaging region of the sample 50. Reflected light L112 made incident from a direction inclined with respect to the Z-axis direction and reflected by the sample 50 is made incident on the perforated concave mirror 121. A hole 121a is provided in the center of the perforated concave mirror 121.

The reflected light L112 reflected by the perforated concave mirror 121 is made incident on the convex mirror 122. The convex mirror 122 reflects the reflected light L112 made incident from the perforated concave mirror 121 toward the hole 121a of the perforated concave mirror 121. The reflected light L112 passing through the hole 121a is detected by the detector 123. The detector 123 may be a detector 123 that includes a TDI (Time Delay Integration) sensor.

The detector 123 acquires image data of the sample 50. The detector 123 includes a plurality of imaging elements linearly arranged in a row in one direction. Linear image data captured by the plurality of imaging elements linearly arranged in a row is called one-dimensional image data or one frame. The detector 123 acquires a plurality of one-dimensional image data, by scanning in a direction orthogonal to the one direction. The imaging element is, for example, a CCD (Charge Coupled Device). Note that, the imaging element is not limited to a CCD.

In this way, the imaging optical system 120 focuses the reflected light L112 from the sample 50 illuminated by the illumination light L111, and acquires image data of the sample 50 by detecting the focused reflected light L112 by the detector 123. The image data is, for example, two-dimensional image data.

Information such as a defect image of the sample 50 is included in the reflected light L112. Positive reflected light of the illumination light L111 made incident on the sample 50 from a direction inclined with respect to the Z-axis direction is detected by the imaging optical system 120. In a case where a defect is present in the sample 50, a defect image is observed as a dark image. Such an observation method is called bright-field observation. A plurality of one-dimensional image data of the sample 50 acquired by the detector 123 is output to the inspection apparatus 10 to be processed into two-dimensional image data.

The inspection apparatus 10 is connected to the imaging optical system 120 by a signal line or wirelessly. The inspection apparatus 10 receives image data of the sample 50 from the detector 123 in the imaging optical system 120. The inspection apparatus 10 performs image processing of the image data of the sample 50 received from the detector 123 as a two-dimensional captured image G10. The other functions and configurations in the inspection apparatus 10 are as described in the embodiments up to this point.

The sample 50 is, for example, an EUV mask responding to EUV light. Note that, the sample 50 is not limited to an EUV mask. The sample 50 may be a photomask responding to the illumination light L111 with another wavelength. Moreover, as described above, the sample 50 may be a semiconductor substrate, a semiconductor chip, a semiconductor apparatus or the like.

Heretofore, while embodiments of the present disclosure have been described, the present disclosure includes appropriate modifications that do not compromise the objectives and benefits thereof, and is not limited by the embodiments. Moreover, each configuration in the embodiments may be appropriately combined. The inspection apparatus and inspection program shown below are within the technical range of the embodiments.

### (Supplementary Note A1)

An inspection apparatus comprising: a specification unit configured to specify a continuous region in a sample in which at least one pattern is formed, the continuous region being where a substantially equivalent predetermined property is continuous in a first direction, an acquisition unit configured to acquire a difference image based on a comparison between a captured image and a reference image of the sample, a candidate specification unit configured to specify a defect candidate on the continuous region based on the difference image, a generation unit configured to generate a parameter distribution of the difference image along the first direction for at least one part of the continuous region to which the defect candidate belongs, and a determination unit configured to determine authenticity for the defect candidate based on the parameter distribution.

### (Supplementary Note A2)

The inspection apparatus described in Supplementary Note A1, in which the generation unit is configured to generate the parameter distribution for a peripheral region different from the defect candidate in the continuous region based on a statistical value of a parameter of the difference image in the peripheral region.

### (Supplementary Note A3)

The inspection apparatus described in Supplementary Note A2, in which the generation unit is configured to generate the parameter distribution for a defect candidate region that includes the defect candidate based on a difference between a parameter of the difference image in the defect candidate region and the statistical value.

### (Supplementary Note A4)

The inspection apparatus described in Supplementary Note A3, in which the determination unit is configured to determine whether or not there is a peak value that satisfies a predetermined condition based on the parameter distribution, and the predetermined condition includes a condition that a difference between the parameter of the difference image in the defect candidate region and the statistical value has a predetermined amount.

### (Supplementary Note A5)

The inspection apparatus described in Supplementary Note A3, in which the determination unit is configured to determine whether or not there is a peak value that satisfies a predetermined condition based on the parameter distribution, and the predetermined condition includes a condition that a first difference value matches a second difference value to a predetermined extent, the first difference value being a difference value between the parameter of the difference image in the defect candidate region and the statistical value of a parameter of the difference image for a first peripheral region that is on a first side of the first direction with respect to the defect candidate, within peripheral regions different from the defect candidate in the continuous region, and the second difference value being a difference value between the parameter of the difference image in the defect candidate region and the statistical value of a parameter of the difference image for a second peripheral region that is on a second side of the first direction with respect to the defect candidate, within peripheral regions different from the defect candidate in the continuous region.

### (Supplementary Note B1)

An inspection apparatus comprising: at least one memory configured to store a command group, and at least one processor configured to execute the command group to specify a continuous region in a sample in which at least one pattern is formed, the continuous region being where a substantially equivalent predetermined property is continuous in a first direction, acquire a difference image based on a comparison between a captured image and a reference image of the sample, and determine a defect in a predetermined processing region within the continuous region in the difference image, based on a parameter based on the difference image in a center region, a parameter based on the difference image in a first peripheral region more on a first side in the first direction than the center region, and a parameter based on the difference image in a second peripheral region more on a second side in the first direction than the center region.

### (Supplementary Note C1)

A non-transitory computer-readable medium storing an inspection program that causes a computer to execute the steps of: specifying a continuous region in a sample in which at least one pattern is formed, the continuous region being where a substantially equivalent predetermined property is continuous in a first direction, acquiring a difference image based on a comparison between a captured image and a reference image of the sample, and determining a defect in a predetermined processing region within the continuous region in the difference image, based on a parameter based on the difference image in a center region, a parameter based on the difference image in a first peripheral region more on a first side in the first direction than the center region, and a parameter based on the difference image in a second peripheral region more on a second side in the first direction than the center region.

The above described inspection program includes a command group (or software code) for causing a computer to perform one or more of the functions described in the embodiments, in a case where read by the computer. The program may be stored in a non-transitory computer readable media or tangible storage media. Examples of computer readable media or tangible storage media, while not limited, include random-access memory (RAM), read-only memory (ROM), flash memory, solid-state drive (SSD) or other memory technologies, CD-ROM, digital versatile disc (DVD), Blu-ray (Registered trademark) disc or other optical disc storage, magnetic cassette, magnetic tape, magnetic disk storage, or other magnetic storage devices. The program may be transmitted on transitory computer readable media or communication media. Examples of transitory computer readable media or transmission media, while not limited, include electrical, optical, acoustic or other forms of propagation signals.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The first to fourth embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An inspection apparatus comprising:
a specification unit configured to specify a continuous region in a sample in which at least one pattern is formed, the continuous region being where a substantially equivalent predetermined property is continuous in a first direction;
an acquisition unit configured to acquire a difference image based on a comparison between a captured image and a reference image of the sample; and
a determination unit configured to determine a defect in a predetermined processing region within a region corresponding to the continuous region in the difference image, based on a parameter based on the difference image in a center region, a parameter based on the difference image in a first peripheral region more on a first side in the first direction than the center region, and a parameter based on the difference image in a second peripheral region more on a second side in the first direction than the center region.

2. The inspection apparatus according to claim 1, wherein:
the determination unit is configured to specify a defect candidate region that includes a pixel having a parameter of a predetermined range in the difference image, and
the determination unit is configured to set a region that includes the defect candidate region as the processing region.

3. The inspection apparatus according to claim 1, wherein:
the determination unit is configured to convert a parameter of each pixel of the difference image into a conversion parameter by applying a conversion operator to the processing region, the conversion operator being configured to convert the parameter, and
the determination unit is configured to determine the defect based on the converted conversion parameter.

4. The inspection apparatus according to claim 3, wherein:
the conversion operator is a kernel having a center part that includes one or more cells, a first peripheral part that includes two or more cells more on the first side than the center part, and a second peripheral part that includes two or more cells more on the second side than the center part,
the determination unit is configured to calculate a first defect signal from the parameter of a concerned pixel and a first statistical value in the parameter of a first peripheral region pixel group consisting of pixels of the difference image at positions corresponding to the cells of the first peripheral part, the concerned pixel being a pixel of the difference image at a position corresponding to each of the one or more cells of the center part,
the determination unit is configured to calculate a second defect signal from the parameter of the concerned pixel and a second statistical value in the parameter of a second peripheral region pixel group consisting of pixels of the difference image at positions corresponding to the cells of the second peripheral part, and
the determination unit is configured to convert the parameter of the concerned pixel into the conversion parameter based on a condition satisfied by the first defect signal and the second defect signal.

5. The inspection apparatus according to claim 4, wherein the first statistical value and the second statistical value each include at least one of an average value and a standard deviation.

6. The inspection apparatus according to claim 4, wherein:
the condition includes a first condition that a sign of the first defect signal and a sign of the second defect signal are equal to each other, and
the condition includes a second condition that an absolute value of the first defect signal is larger than a value obtained by dividing an absolute value of the second defect signal by a number larger than 1 and an absolute value of the second defect signal is larger than a value obtained by dividing an absolute value of the first defect signal by a number larger than 1.

7. The inspection apparatus according to claim 6, wherein:
the determination unit is configured to convert the parameter of the concerned pixel into a defect signal sum in a case where both of the first condition and the second condition are satisfied, the defect signal sum being a sum of the first defect signal and the second defect signal, and
the determination unit is configured to convert the parameter of the concerned pixel into a specific value in a case where at least one of the first condition and the second condition is not satisfied.

8. The inspection apparatus according to claim 1, wherein the determination unit is configured to determine the defect in the center region based on:
a first defect signal in which a parameter of a pixel of the difference image in the center region is corrected based on a first statistical value of a parameter of a pixel of the difference image in the first peripheral region, and
a second defect signal in which a parameter of a pixel of the difference image in the center region is corrected based on a second statistical value of a parameter of a pixel of the difference image in the second peripheral region.

9. The inspection apparatus according to claim 8, wherein the determination unit is configured to determine the defect in the center region based on a first condition that includes a sign of the first defect signal and a sign of the second defect signal having a predetermined relationship.

10. The inspection apparatus according to claim 8, wherein the determination unit is configured to determine the defect in the center region based on a second condition that includes both of the first defect signal and the second defect signal having a large value to the same extent.

11. The inspection apparatus according to claim 8, wherein the determination unit is configured to determine the defect in the center region in a case where both a first condition that includes a sign of the first defect signal and a sign of the second defect signal having a predetermined relationship and a second condition that includes both of the first defect signal and the second defect signal having a large value to the same extent are satisfied.

12. The inspection apparatus according to claim 1, wherein:
the sample has a plurality of groups spaced apart in the first direction, each of the groups being where two of the at least one pattern extending in a second direction intersecting the first direction and/or two pattern intervals extending in a second direction intersecting the first direction are adjacent in the second direction with at least one gap portion interposed therebetween, and
the continuous region includes a plurality of the at least one gap portion arranged in a row in the first direction.

13. The inspection apparatus according to claim 1, wherein:
the sample has a plurality of groups spaced apart in the first direction, each of the groups being of a plurality of circular patterns arranged in a row with at least one gap portion interposed therebetween in a second direction intersecting the first direction, and
the continuous region includes a plurality of the at least one gap portion arranged in a row in the first direction.

14. The inspection apparatus according to claim 12, wherein the sample includes the defect in the gap portion.

15. An inspection method comprising the steps of:
specifying a continuous region in a sample in which at least one pattern is formed, the continuous region being where a substantially equivalent predetermined property is continuous in a first direction;
acquiring a difference image based on a comparison between a captured image and a reference image of the sample; and
determining a defect in a predetermined processing region within a region corresponding to the continuous region in the difference image, based on a parameter based on the difference image in a center region, a parameter based on the difference image in a first peripheral region more on a first side in the first direction than the center region, and a parameter based on the difference image in a second peripheral region more on a second side in the first direction than the center region.

16. The inspection method according to claim 15, wherein, in the step of determining:
a defect candidate region that includes a pixel having a parameter of a predetermined range in the difference image is specified, and
a region that includes the defect candidate region is set as the processing region.

17. The inspection method according to claim 15, wherein, in the step of determining:
a parameter of each pixel of the difference image is converted into a conversion parameter by applying a conversion operator to the processing region, the conversion operator being configured to convert the parameter, and
the defect is determined based on the converted conversion parameter.

18. The inspection method according to claim 17, wherein:
the conversion operator is a kernel having a center part that includes one or more cells, a first peripheral part that includes two or more cells more on the first side than the center part, and a second peripheral part that includes two or more cells more on the second side than the center part, and
in the step of determining:
a first defect signal is calculated from the parameter of a concerned pixel and a first statistical value in the parameter of a first peripheral region pixel group consisting of pixels of the difference image at positions corresponding to the cells of the first peripheral part, the concerned pixel being a pixel of the difference image at a position corresponding to each of the one or more cells of the center part,
a second defect signal is calculated from the parameter of the concerned pixel and a second statistical value in the parameter of a second peripheral region pixel group consisting of pixels of the difference image at positions corresponding to the cells of the second peripheral part, and
the parameter of the concerned pixel is converted into the conversion parameter based on a condition satisfied by the first defect signal and the second defect signal.

19. The inspection method according to claim 18, wherein the first statistical value and the second statistical value each include at least one of an average value and a standard deviation.

20. The inspection method according to claim 18, wherein, in the step of determining:
the condition includes a first condition that a sign of the first defect signal and a sign of the second defect signal are equal to each other, and
the condition includes a second condition that an absolute value of the first defect signal is larger than a value obtained by dividing an absolute value of the second defect signal by a number larger than 1 and an absolute value of the second defect signal is larger than a value obtained by dividing an absolute value of the first defect signal by a number larger than 1.

21. The inspection method according to claim 20, wherein, in the step of determining:
the parameter of the concerned pixel is converted into a defect signal sum in a case where both of the first condition and the second condition are satisfied, the defect signal sum being a sum of the first defect signal and the second defect signal, and
the parameter of the concerned pixel is converted into a specific value in a case where at least one of the first condition and the second condition is not satisfied.

22. The inspection method according to claim 15, wherein, in the step of determining, the defect in the center region is determined based on:
a first defect signal in which a parameter of a pixel of the difference image in the center region is corrected based on a first statistical value of a parameter of a pixel of the difference image in the first peripheral region, and
a second defect signal in which a parameter of a pixel of the difference image in the center region is corrected based on a second statistical value of a parameter of a pixel of the difference image in the second peripheral region.

23. The inspection method according to claim 22, wherein:
in the step of determining, the defect in the center region is determined based on a first condition that includes a sign of the first defect signal and a sign of the second defect signal having a predetermined relationship.

24. The inspection method according to claim 22, wherein:
in the step of determining, the defect in the center region is determined based on a second condition that includes both of the first defect signal and the second defect signal having a large value to the same extent.

25. The inspection method according to claim 22, wherein:
in the step of determining, the defect in the center region is determined in a case where both a first condition that includes a sign of the first defect signal and a sign of the second defect signal having a predetermined relationship and a second condition that includes both of the first defect signal and the second defect signal having a large value to the same extent are satisfied.

26. The inspection method according to claim 15, wherein:
the sample has a plurality of groups spaced apart in the first direction, each of the groups being where two of the at least one pattern extending in a second direction intersecting the first direction and/or two pattern intervals extending in a second direction intersecting the first direction are adjacent in the second direction with at least one gap portion interposed therebetween, and
the continuous region includes a plurality of the at least one gap portion arranged in a row in the first direction.

27. The inspection method according to claim 15, wherein:
the sample has a plurality of groups spaced apart in the first direction, each of the groups being of a plurality of circular patterns arranged in a row with at least one gap portion interposed therebetween in a second direction intersecting the first direction, and
the continuous region includes a plurality of the at least one gap portion arranged in a row in the first direction.

28. The inspection method according to claim 26, wherein the sample includes the defect in the gap portion.
